(19) United States
(12) Patent Application Publication
(10) Pub. No.: US 2017/0125038 A1
(43) Pub. Date: May 4, 2017

(54) TRANSFER FUNCTION TO GENERATE LOMBARD SPEECH FROM NEUTRAL SPEECH

(71) Applicant: Ford Global Technologies, LLC, Dearborn, MI (US)

(72) Inventors: Ali Hassani, Ann Arbor, MI (US); Scott Andrew Amman, Milford, MI (US); Francois Charette, Tracy, CA (US); John Edward Huber, Novi, MI (US); Brigitte Frances Mora Richardson, West Bloomfield, MI (US); Gintaras Vincent Puskorius, Novi, MI (US); An Ji, Novi, MI (US); Ranjani Rangarajan, Dearborn, MI (US)

(21) Appl. No.: 14/931,132

(22) Filed: Nov. 3, 2015

(51) Int. Cl. G10L 25/87; G10L 15/02; G10L 15/06; G10L 15/22

(52) U.S. Cl. CPC G10L 25/87; G10L 15/22; G10L 15/02; G10L 15/063; G10L 2015/025; G10L 2015/0631

(57) ABSTRACT

A controller may be programmed to create a speech utterance set for speech recognition training by, in response to receiving data representing a neutral utterance and parameter values defining signal noise, generating data representing a Lombard effect version of the neutral utterance using a transfer function associated with the parameter values and defining distortion between neutral and Lombard effect versions of a same utterance due to the signal noise.

### TECHNICAL FIELD

The present disclosure relates to systems and methods for generating Lombard effect speech.

### BACKGROUND

The Lombard effect is an involuntary tendency of a person speaking in a noisy environment to introduce distortions into their speech so as to ensure understanding in the presence of audible interference. A decrease in auditory feedback or the speaker's perception of their own voice brought on by ambient or background noise may cause the speaker, for example, to alter volume, pitch frequency and variability, cadence, and other characteristics affecting speech quality. In some cases the speaker will alter their speech pattern consistent with the Lombard effect even if only the listener, and not the speaker, is perceived to be in a noisy environment.

A vehicle occupant may perceive a range of ambient and background noise types and levels produced by a variety of sources under different driving conditions, such as, when a vehicle is idling in a parking lot or when a vehicle is traveling on a highway with fully open windows. The extent of noise exposure may further vary with vehicle exterior and interior design, energy source type, chassis, suspension, wheels, and other specifications.

### SUMMARY

A system includes a controller programmed to create a speech utterance set associated with a specified noise signal for speech recognition training by applying a same transfer function to each of a set of neutral utterances to generate a corresponding Lombard effect version. The transfer function defines distortion between neutral and Lombard effect versions of a same utterance due to the specified noise signal.

A method includes creating a speech utterance set associated with a specified noise signal for speech recognition training by applying via a controller a same transfer function to each of a set of neutral utterances to generate a corresponding Lombard effect version, wherein the transfer function defines distortion between neutral and Lombard effect versions of a same utterance due to the specified noise signal.

A system includes a controller programmed to create a speech utterance set for speech recognition training by, in response to receiving data representing a neutral utterance and parameter values defining signal noise, generating data representing a Lombard effect version of the neutral utterance using a transfer function associated with the parameter values and defining distortion between neutral and Lombard effect versions of a same utterance due to the signal noise.

### BRIEF DESCRIPTION OF THE DRAWINGS

FIG. 1 is a block diagram illustrating a vehicle equipped with an automatic speech recognition (ASR) system;

FIG. 2 is a block diagram illustrating a system for generating Lombard effect speech from neutral speech;

FIGS. 3-4 are block diagrams illustrating systems for generating a Lombard effect speech transfer function;

FIG. 5 is a flowchart illustrating an algorithm for generating a Lombard effect speech transfer function; and

FIG. 6 is a flowchart illustrating an algorithm for generating Lombard effect speech from neutral speech.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

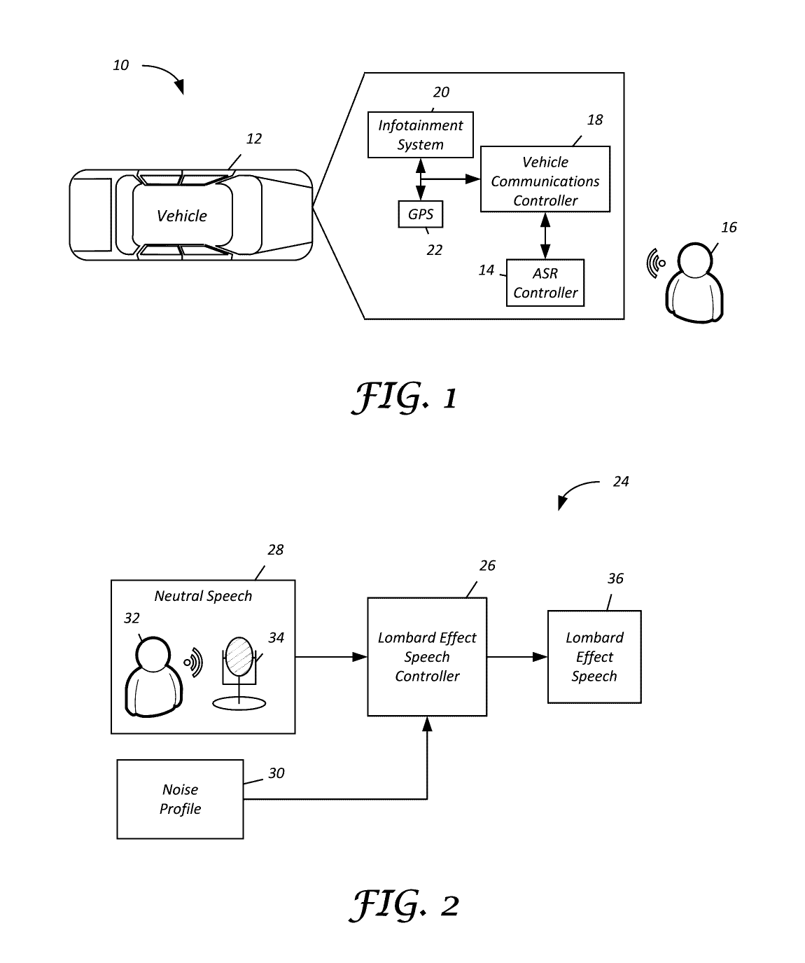

In reference to FIG. 1, a speech-recognition system 10 for a vehicle 12 is shown. The system 10 is configured to receive user-issued voice commands and to take actions according to the received commands. The vehicle 12 includes an automatic speech-recognition (ASR) controller 14. The ASR controller 14 is configured to receive spoken language, or speech, input produced by a vehicle occupant (or user) 16 that invokes a command to one or more vehicle subsystems, such as, but not limited to, a navigation subsystem, an infotainment subsystem, a hands-free phone subsystem, and so on. The ASR controller 14 is configured to interpret the spoken input using, for example, speech signal processing and transmit a signal indicative of a digital interpretation of the command.

The ASR controller 14 may apply one or more methods to perform speech signal processing using, for example, acoustic, pronunciation, and language modeling or a combination thereof. Speech signal processing techniques may include, but are not limited to, statistical methods, e.g., hidden Markov model (HMM), Viterbi algorithm, unigram models, and n-gram models, methods using neural networks, e.g., recurrent neural networks (RNNs), time delay neural networks (TDNN), convolutional neural networks (CNNs), neural net language models, and so on.

While the ASR controller 14 shown in FIG. 1 is a stand-alone controller, in some embodiments the controller 14 may be incorporated as part of a vehicle communications controller 18 or another vehicle controller or system. The ASR controller 14 may be configured to transmit and receive signals from other vehicle controllers, such as, but not limited to, infotainment system controller 20, global positioning system (GPS) controller 22, and so on, via multiplexed data link communication bus, such as a High/Medium Speed Controller Area Network (CAN) bus, a Local Interconnect Network (LIN), or any such suitable data link communication bus generally situated to facilitate data transfer between control modules in a vehicle.

The user 16 may invoke a command directed to, for example, a navigation system for guidance to a particular location, a telematics system for contacting a person or a business on a contact list, an entertainment system for playing a particular music track, and so on. When invoking a command, the user 16 may perceive a range of background and ambient noise types and levels produced by a variety of sources under different driving conditions, such as, for example, when the vehicle 12 is idling in a parking lot or when the vehicle 12 is traveling on a highway with fully open windows. The extent of the noise perception may further vary with exterior and interior design, energy source type, chassis, suspension, wheels, and other specifications of the vehicle 12.

In response to the perception of the surrounding ambient and background noise, the user 16 may involuntarily distort their speech, i.e., introduce a Lombard effect, so as to ensure understanding despite audible interference. In one example, the speaker may alter one or more characteristics affecting speech quality, such as, but not limited to, volume, pitch frequency and variability, cadence, and so on. The ASR controller 14 may alter the applied speech signal processing techniques in response to receiving the speech containing one or more distortions due to speaker's perceived decrease in auditory feedback brought on, for example, by the perceived ambient and background noise in the vehicle 12.

The ASR controller 14 is configured to receive distorted or altered speech, i.e., Lombard effect speech, from a Lombard effect speech controller (or Lombard controller) 26. This aspect of the disclosure will be described in further detail in reference to FIG. 2. The ASR controller 14 may process the Lombard effect speech received from the Lombard controller 26 using the above-mentioned or other speech signal processing methods.

In reference to FIG. 2, a system 24 for generating a Lombard effect speech is shown. The system 24 includes the Lombard controller 26 configured to receive a neutral utterance 28 and a noise profile 30. The neutral utterance 28, or clean speech, may be an utterance produced in a quiet, non-reverberant environment and so on. The Lombard controller 26 is further configured to generate a Lombard effect utterance 36 from the neutral utterance 28 based on the received noise profile 30. The Lombard effect utterance 36 may be an utterance having altered characteristics affecting speech quality due to, for example, perceived decrease in auditory feedback. In one example, the Lombard controller 26 may transmit the generated Lombard effect utterance 36 to the ASR controller 14 for speech recognition processing.

The Lombard controller 26 may receive the neutral utterance 28 and the noise profile 30 using a graphical user interface (GUI) (not shown) of an electronic device, such as, but not limited to, a computer, a mobile device, and so on. In one example, the neutral utterance 28 is generated when a speaker 32 speaks into a microphone 34, e.g., close talk. In another example, the neutral utterance 28 is generated when the microphone 34 receives audio signal generated using an audio speaker (not shown) and a head and torso simulator (HATS) (not shown). In yet another example, the Lombard controller 26 may receive the neutral utterance 28 as a recorded audio file digitally stored in a neutral utterance database.

The received noise profile 30 may include one or more audio signal parameters, such as sound pressure, sound pressure level or loudness, sound intensity or sound power, frequency content, spectral content, and so on. The noise profile 30 may, for example, include parameters of an audio signal produced by the vehicle 12 under one or more operating conditions. In one example, the noise profile 30 may be representative of a noise signal audible in an interior of the vehicle 12 when the vehicle 12 is being driven on a highway with windows fully open. In another example, the noise profile 30 may be representative of a noise signal audible when the vehicle 12 is idling inside a parking structure. In one example, the noise profile 30 may be specified using predetermined values of frequency, bandwidth, power, and other sound characteristics. In another example, the noise profile 30 may be specified using a noise type selection associated with one or more vehicle design specifications, road surfaces, vehicle speeds, weather and traffic conditions, vehicle climate control and infotainment system settings, or a combination thereof.

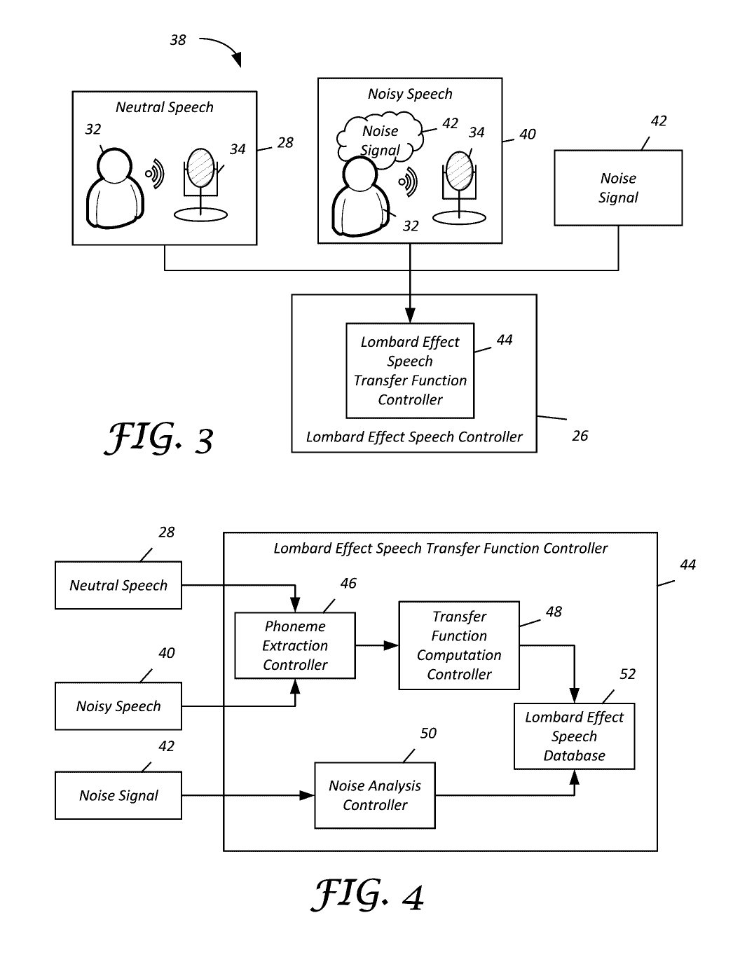

The Lombard controller 26 generates the Lombard effect utterance 36 from the neutral utterance 28 based on the received noise profile 30 using a transfer function generated, for example, by a Lombard effect speech transfer function controller (or transfer function controller) 44. This aspect of the present disclosure will be described in further detail in reference to FIG. 3. While the Lombard controller 26 and the transfer function controller 44 as described in reference to at least FIG. 3 are shown as separate controllers, in some embodiments their functions could be combined in a single controller. In one example, the Lombard controller 26 may transmit the generated Lombard effect utterance 36 to the ASR controller 14 for speech recognition processing.

In reference to FIG. 3, a system 38 for generating a Lombard effect speech transfer function is shown. The transfer function controller 44 of the Lombard controller 26 is configured to receive the neutral utterance 28, a noisy utterance 40, and a noise signal 42. The transfer function controller 44 is further configured to generate a Lombard effect speech transfer function, hereinafter referred to as Lombard transfer function, in response to receiving the neutral utterance 28 and the noisy utterance 40. The transfer function controller 44 is also configured to associate the generated Lombard transfer function with a noise profile of the noise signal 42. The transfer function controller 44 may be configured to transmit the generated Lombard transfer function, in response to a request, to the Lombard controller 26.

The Lombard controller 26 may, in response to receiving the neutral utterance 28 and the noise profile 30, request from the transfer function controller 44 the Lombard transfer function. In one example, the request from the Lombard controller 26 may be based on the noise profile 30. The Lombard controller 26 may generate from the received neutral utterance 28 the Lombard effect utterance 36 using the received Lombard transfer function. In one example, the Lombard controller 26 may transmit the generated Lombard effect utterance 36 to the ASR controller 14 for speech recognition processing.

As described previously in reference to FIG. 2, the neutral utterance 28, or clean speech, may be generated in a quiet, non-reverberant environment when the speaker 32 speaks into the microphone 34. In another example, the neutral utterance 28 is generated when the microphone 34 receives audio signal generated through the audio speaker and the HATS. In yet another example, the neutral utterance 28 may be a recorded audio file digitally stored in a recorded utterance database. The transfer function controller 44 may receive the neutral utterance 28 using the GUI of an electronic device, such as, but not limited to, a computer, a mobile device, and so on.

The noisy utterance 40 may be generated when the speaker 32 speaks into the microphone 34 while in a presence of, or while otherwise perceiving, the noise signal 42. In one example, the noisy utterance 40 may be generated when the speaker 32 speaks into the microphone 34 while perceiving through headphones (not shown) a sound recording of the noise signal 42. In one example, the transfer function controller 44 may receive the noisy utterance 40 using the GUI of an electronic device, such as, but not limited to, a computer, a mobile device, and so on.

The perception of the noise signal 42 may cause the speaker 32 to involuntarily distort their speech, i.e., introduce a Lombard effect, so as to ensure understanding despite audible interference. In one example, the speaker 32 may alter one or more characteristics affecting speech quality, such as, but not limited to, volume, pitch frequency and variability, cadence, and so on. The noisy utterance 40 received by the transfer function controller 44 may contain characteristics of a Lombard effect introduced by the speaker 32 into the utterance when speaking into the microphone 34 and contemporaneously perceiving the noise signal 42.

The transfer function controller 44 may be configured to identify the noise profile of the noise signal 42 associated with the noisy utterance 40. The transfer function controller 44 may classify or tag the identified noise profile of the noise signal 42 according to the captured metrics, such as, but not limited to, amplitude, frequency content, spectral content, domain, and so on. The transfer function controller 44 may also classify or tag the identified noise profile of the noise signal 42 according to the nature of the sound or a combination of sounds, such as, but not limited to, interior stereo noise, traffic noise, road surface noise, and so on. The transfer function controller 44 may associate the noise profile of the noise signal 42 with the generated Lombard transfer function.

To identify the noise profile of the noise signal 42 the transfer function controller 44 may analyze the noise signal 42 or the sound recording of the noise signal 42 using signal processing techniques. In one example, the transfer function controller 44 may use signal conversion, such as analog-to-digital and digital-to-analog conversion or a combination thereof, signal filtering, continuous- and discrete-time signal modeling, various sampling rates, and other signal processing techniques to capture various metrics associated with the noise signal 42, such as, but not limited to, amplitude, frequency content, domain, and so on. The transfer function controller 44 may analyze the noise signal 42 using one or more digital signal processors, application-specific integrated circuits (ASICs), general purpose microprocessors, field-programmable gate arrays (FPGAs), digital signal controllers, and stream processors, among other components.

The noise profile of the noise signal 42 may be a noise produced by the vehicle 12 under one or more operating conditions. In one example, the noise profile of the noise signal 42 may be of a noise audible in an interior of the vehicle 12 when the vehicle 12 is being driven on a highway with windows fully open. In another example, the noise profile of the noise signal 42 may be of a noise audible when the vehicle 12 is idling inside a parking structure.

The sound recording of the noise signal 42 may be generated when the vehicle 12 is operated in various environments, such as, but not limited to, a test track, a dynamometer, a public road, and so on. The sound recording may, for example, capture the noise signal 42 produced on various road surfaces, under various vehicle speeds, in various weather and traffic conditions, or a combination thereof. In one example, the sound recording of the noise signal 42 may be generated for vehicles of varying interior and exterior design, energy source types, chassis, suspension, wheels, and other vehicle design specifications. Other ambient or background noise types, such as, but not limited to, noises produced by other occupants, a vehicle stereo or video player, a mobile device, and so on, are also contemplated.

In reference to FIG. 4, the transfer function controller 44 for generating the Lombard transfer function is shown. The transfer function controller 44 includes a phoneme controller 46 configured to receive the neutral utterance 28 and the noisy utterance 40. The phoneme controller 46 is further configured to extract one or more phonemes, or a minimum unit of sound that has semantic content, from the received neutral and noisy utterances 28, 40.

In one example, the phoneme controller 46 may extract phonemes using hidden Markov models (HMM) in combination with a three-state left-to-right topology for each phoneme. Other phone extraction methods, such as, but not limited to, a Gaussian mixture model (GMM), linear predictive analysis (LPC), linear predictive cepstral coefficients (LPCC), perceptual linear predictive coefficients (PLP), mel-frequency cepstral coefficients (MFCC), power spectral analysis (FFT), mel scale cepstral analysis (MEL), relative spectral filtering of log domain coefficients (RASTA), first order derivative coefficients (DELTA), and so on, are also contemplated.

The transfer function controller 44 includes a transfer function computation controller 48 configured to receive the extracted phonemes from the phoneme controller 46 and generate the Lombard transfer function based on the received phonemes. In one example, the transfer function computation controller 48 generates the Lombard transfer function using frequency spectrum analysis, such as, but not limited to, Fourier transform, fast-Fourier transform, discrete-time Fourier transform, and so on. Other methods for determining the Lombard transfer function based on the received extracted phonemes of the neutral and noisy utterances 28, 40 are also contemplated.

The transfer function controller 44 includes a noise analysis controller 50 configured to receive the noise signal 42 associated with the noisy utterance 40. The noise analysis controller 50 may identify the noise profile of the noise signal 42 associated with the noisy utterance 40. The noise analysis controller 50 may classify or tag the identified noise profile of the noise signal 42 according to the captured metrics, such as, but not limited to, amplitude, frequency content, spectral content, domain, and so on. The noise analysis controller 50 may also classify or tag the identified noise profile of the noise signal 42 according to the nature of the sound or a combination of sounds, such as, but not limited to, interior stereo noise, traffic noise, road surface noise, and so on. The noise analysis controller 50 may transmit the noise profile of the noise signal 42 to a Lombard effect speech database 52 for association with the Lombard transfer function generated based on the neutral and noisy utterances 28, 40.

To identify the noise profile of the noise signal 42 the noise analysis controller 50 may analyze the noise signal 42 or the sound recording of the noise signal 42 using signal processing techniques. In one example, the noise analysis controller 50 may use signal conversion, such as analog-to-digital and digital-to-analog conversion or a combination thereof, signal filtering, continuous- and discrete-time signal modeling, various sampling rates, and other signal processing techniques to capture various metrics associated with the noise signal 42, such as, but not limited to, amplitude, frequency content, domain, and so on. The noise analysis controller 50 may analyze the noise signal 42 using one or more digital signal processors, application-specific integrated circuits (ASICs), general purpose microprocessors, field-programmable gate arrays (FPGAs), digital signal controllers, and stream processors, among other components.

The noise profile of the noise signal 42 may be a noise produced by the vehicle 12 under one or more operating conditions. In one example, the noise profile of the noise signal 42 may be of a noise audible in an interior of the vehicle 12 when the vehicle 12 is being driven on a highway with windows fully open. In another example, the noise profile of the noise signal 42 may be of a noise audible when the vehicle 12 is idling inside a parking structure.

The sound recording of the noise signal 42 may be generated when the vehicle 12 is operated in various environments, such as, but not limited to, a test track, a dynamometer, a public road, and so on. The sound recording may, for example, capture the noise signal 42 produced on various road surfaces, under various vehicle speeds, in various weather and traffic conditions, or a combination thereof. In one example, the sound recording of the noise signal 42 may be generated for vehicles of varying interior and exterior design, energy source types, chassis, suspension, wheels, and other vehicle design specifications. Other ambient and background noise types, such as, but not limited to, noises produced by other occupants, a vehicle stereo or video player, a mobile device, and so on, are also contemplated.

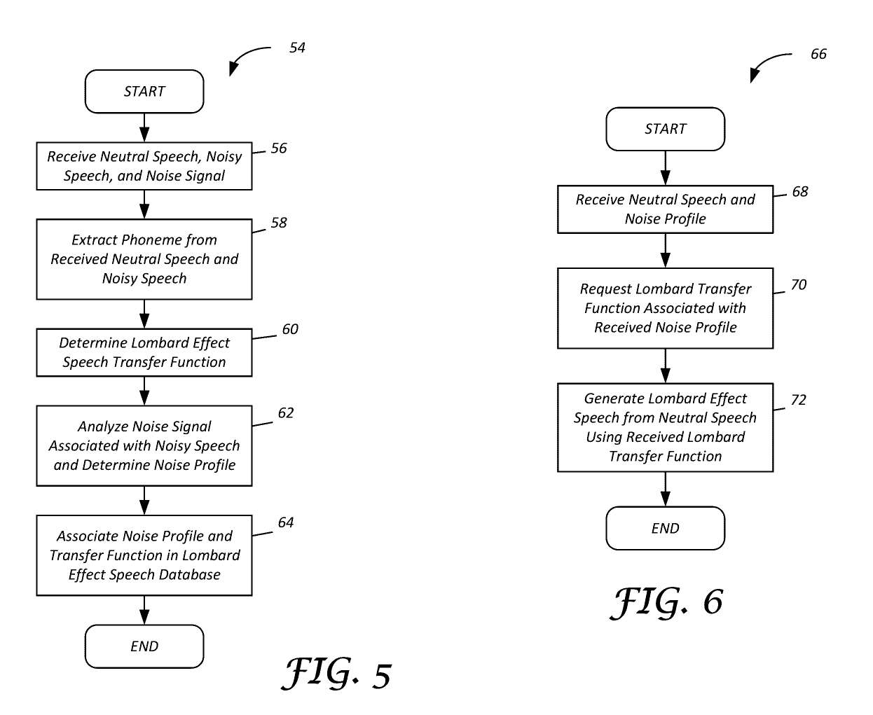

In reference to FIG. 5, a control strategy 54 for determining the Lombard transfer function based on the received neutral and noisy utterances 28, 40 is shown. The control strategy 54 may begin at block 56 where the transfer function controller 44 receives the neutral utterance 28, the noisy utterance 40, and the noise signal 42. The neutral utterance 28, or clean speech, may be an utterance generated in a quiet, non-reverberant environment when the speaker 32 speaks into the microphone 34 and the noisy utterance 40 may be an utterance generated when the speaker 32 speaks into the microphone 34 while perceiving the noise signal 42.

At block 58 the transfer function controller 44 extracts one or more phonemes from the received neutral and noisy utterances 28, 40. In one example, the transfer function controller 44 extracts the phonemes using statistical modeling and other techniques, such as, but not limited to, a hidden Markov model (HMM), a Gaussian mixture model (GMM), linear predictive analysis (LPC), linear predictive cepstral coefficients (LPCC), perceptual linear predictive coefficients (PLP), mel-frequency cepstral coefficients (MFCC), power spectral analysis (FFT), mel scale cepstral analysis (MEL), relative spectral filtering of log domain coefficients (RASTA), first order derivative coefficients (DELTA), and so on.

At block 60 the transfer function controller 44 determines the Lombard transfer function based on the extracted phonemes using, for example, frequency spectrum analysis via a Fourier transform, a fast-Fourier transform, a discrete-time Fourier transform, and so on. At block 62 the transfer function controller 44 analyzes the noise signal 42 associated with the noisy utterance 40 and determines the noise profile. In one example, the transfer function controller 44 determines the noise profile using signal processing techniques, such as signal conversion, signal filtering, continuous- and discrete-time signal modeling, various sampling rates, and others in capturing amplitude, frequency content, domain, and other metrics of the noise signal 42.

At block 64 the transfer function controller 44 associates the determined noise profile of the noise signal 42 with the Lombard transfer function. In one example, the transfer function controller 44 stores the associated data in the Lombard effect speech database 52. In one example, the transfer function controller 44, in response to a request from the Lombard controller 26, may transmit the Lombard transfer function associated with the noise profile of the noise signal 42. At this point the control strategy 54 may end. In some embodiments the control strategy 54 as described in reference to FIG. 5 may be repeated in response to receiving the neutral and noisy utterances 28, 40 and the noise signal 42 or in response to receiving another input or request.

In reference to FIG. 6, a control strategy 66 for generating Lombard effect speech from neutral speech based on a noise profile is shown. The control strategy 66 may begin at block 68 where the Lombard controller 26 receives the neutral utterance 28 and a noise profile 30, e.g., one or more noise parameters, via, for example, a GUI of a computer or another electronic device. The Lombard controller 26 at block 70 requests the Lombard transfer function associated with the noise profile 30 in response to receiving the neutral utterance 28 and the noise profile 30.

At block 72 the Lombard controller 26 generates the Lombard effect utterance 36 using the Lombard transfer function associated with the noise profile 30. In one example, the Lombard controller 26 transmits, in response to a request, the Lombard effect utterance 36 to the ASR controller 14 for speech recognition processing. At this point the control strategy 66 may end. In some embodiments the control strategy 66 as described in reference to FIG. 6 may be repeated in response to receiving the neutral utterance 28 and the noise profile 30, e.g., one or more noise parameters, or in response to receiving another input or request.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system comprising:
a controller programmed to create a speech utterance set associated with a specified noise signal for speech recognition training by applying a same transfer function to each of a set of neutral utterances to generate a corresponding Lombard effect version, wherein the transfer function defines distortion between neutral and Lombard effect versions of a same utterance due to the specified noise signal.

2. The system of claim 1, wherein the controller is further programmed to derive the transfer function from phonemes extracted from the neutral and Lombard effect versions of the same utterance.

3. The system of claim 2, wherein the controller is further programmed to extract the phonemes using a hidden Markov model, a Gaussian mixture model, or a linear predictive analysis.

4. The system of claim 1, wherein the distortion includes a change in volume, pitch frequency, pitch variability, or cadence.

5. The system of claim 1, wherein the specified noise signal is defined by signal attributes including amplitude, frequency content, spectral content, or domain.

6. The system of claim 5, wherein the controller is further programmed to identify values of the signal attributes using digital signal processing.

7. The system of claim 1, wherein the specified noise signal is a signal representing audible vehicle cabin noise.

8. The system of claim 1, wherein the controller is further programmed to transmit at least one Lombard effect version of the set to an automatic speech-recognition controller for speech signal processing.

9. A method comprising:
creating a speech utterance set associated with a specified noise signal for speech recognition training by applying via a controller a same transfer function to each of a set of neutral utterances to generate a corresponding Lombard effect version, wherein the transfer function defines distortion between neutral and Lombard effect versions of a same utterance due to the specified noise signal.

10. The method of claim 9 further comprising generating the transfer function using phonemes extracted from the neutral and Lombard effect versions of the same utterance.

11. The method of claim 10 further comprising extracting the phonemes using one of a hidden Markov model, a Gaussian mixture model, or a linear predictive analysis.

12. The method of claim 9, wherein the distortion includes a change in volume, pitch frequency, pitch variability, or cadence.

13. The method of claim 9, wherein the specified noise signal is defined by signal attributes including amplitude, frequency content, spectral content, or domain.

14. The method of claim 13 further comprising identifying values of the signal attributes using digital signal processing.

15. The method of claim 9, wherein the specified noise signal is a signal representing audible vehicle cabin noise.

16. The method of claim 9 further comprising transmitting at least one Lombard effect version of the set to an automatic speech-recognition controller for speech signal processing.

17. A system comprising:
a controller programmed to create a speech utterance set for speech recognition training by, in response to receiving data representing a neutral utterance and parameter values defining signal noise, generating data representing a Lombard effect version of the neutral utterance using a transfer function associated with the parameter values and defining distortion between neutral and Lombard effect versions of a same utterance due to the signal noise.

18. The system of claim 17, wherein the controller is further programmed to generate the transfer function using phonemes extracted from the neutral and Lombard effect versions of the same utterance.

19. The system of claim 17, wherein the parameter values define values for amplitude, frequency content, spectral content, or domain.

20. The system of claim 17, wherein the distortion includes a change in one of a volume, pitch frequency, pitch variability, or cadence.
